(19) United States
(12) Patent Application Publication
(10) Pub. No.: US 2014/0305118 A1
(43) Pub. Date: Oct. 16, 2014

(54) Energy Collector

(71) Applicant: Kam Wa Tai, Hong Kong (HK)

(72) Inventor: Kam Wa Tai, Hong Kong (HK)

(21) Appl. No.: 14/353,307

(22) PCT Filed: Aug. 6, 2012
(86) PCT No.: PCT/CN2012/079703

§ 371 Date: May 23, 2014

(30) Foreign Application Priority Data
Oct. 28, 2011 (HK) 11111686.3

(51) Int. Cl. F03B 13/22; F03B 13/18; F03D 9/00

(52) U.S. Cl. CPC F03B 13/22; F03D 9/008; F03B 13/187
USPC 60/497

(57) ABSTRACT

The patent application discloses an energy collector, which comprises a hydraulic cylinder, a hydraulic motor and a water carrying wheel. A piston in the hydraulic cylinder is connected with a reciprocating type running gear; a water inlet pipe and a water outlet pipe are installed on the hydraulic cylinder; a one-way valve a is arranged in the water inlet pipe; a one-way valve b is arranged in the water outlet pipe; the water outlet pipe is connected with the hydraulic motor; the hydraulic motor is connected with the water carrying wheel in a transmission manner; and a water carrying pipe is installed in the middle of the water carrying wheel.

### TECHNICAL FIELD

The patent application relates to an energy collector.

### BACKGROUND

Nowadays, our energy of economy seems to be operated like a perpetuum mobile. Billions of people enjoy an unprecedented level of life and countries float in a river of assets, which are mostly because that energy industry has established a hugeous network in the whole world that continuously converts petroleum and gas hydrocarbon homologies, natural gas and coal into heat and energy, and endows mobility of modern civilization. For hundreds of years, utilization of fossil energy has reached a saturation state. However, with the gradual depletion of fossil energy exploitation, development of human society and industry will stagnate and even hold back. At present, people start in development and utilization of new energy, for example, water power plant, tidal power generation, wind power generation and the like, most of which convert natural energy into electric energy; moreover, such a facility like the water power plant will change the ecology and unknown risks are hidden. Therefore, it is in badly need of a device converting natural energy into energy that can be utilized by people under the premise of not destroying the environment.

### SUMMARY

The patent application aims at providing an energy collector, which adopts maximum efficiency and smaller cost to convert natural energy into mechanical energy, pneumatic energy or electric energy under the premise of not emitting any greenhouse gas and not changing the ecological environment. The objective of the patent application is realized through the following technical solution.

An energy collector comprises a hydraulic cylinder, a hydraulic motor and a water carrying wheel. A piston in the hydraulic cylinder is connected with a reciprocating type running gear. A water inlet pipe and a water outlet pipe are installed on the hydraulic cylinder. A one-way valve a is arranged in the water inlet pipe, and a one-way valve b is arranged in the water outlet pipe. The water outlet pipe is connected with the hydraulic motor. The hydraulic motor is connected with the water carrying wheel in a transmission manner. A water carrying pipe is installed in the middle of the water carrying wheel.

Further, the water carrying wheel is provided with a spiral pipeline. One end of the pipeline is connected with the water carrying pipe so that the seawater in the pipeline is poured into the end of the water carrying pipe connected with the water carrying pipe in a spiral manner during a rotating process of the water carrying wheel, thus improving a water level.

Further, the reciprocating type running gear is a metal floating block. The metal floating block is arranged on a sea surface and is connected with the piston through a linkage.

Further, the reciprocating type running gear is a wind wheel and a turnplate. The wind wheel is connected with a drive rod through a transmission. The turnplate is installed on the bottom of the drive rod. The piston is hinged with the linkage. The linkage is hinged at the edge of the turnplate.

Further, the hydraulic cylinder is a sleeve type hydraulic cylinder. The piston is sleeved in a sleeve piston. The sleeve piston is sleeved in a cylinder body.

Further, the hydraulic motor is connected with the water carrying wheel through a driving belt.

The patent application has the advantageous effects that the metal floating block or the wind wheel and the turnplate are adopted in the energy collector to drive the hydraulic cylinder to work; meanwhile, the hydraulic cylinder drives the hydraulic motor, and carries seawater out through the water carrying wheel, and converts potential energy or wind energy of waves into utilizable potential energy of water; the seawater after entering a water storage device can be further converted into mechanical energy, pneumatic energy or electric energy, thus realizing to convert natural energy into mechanical energy, pneumatic energy or electric energy under the premise of not emitting any greenhouse gases and not changing the ecological environment. A spiral structure is adopted on water carrying wheel, during rotating, seawater is collected through a pipeline part at the outermost side, and the seawater is carried to the middle of the water carrying wheel through a pipeline the inside of which retracts to the center in a spiral manner, thus improving a water level and increasing the seawater carrying efficiency. Meanwhile, a telescoping type sleeve hydraulic cylinder is adopted, which improves the utilization rate of hydraulic pressure. Meanwhile, an entire system device has simple elements and high standardization degree, which effectively reduces the cost, and is convenient for application and popularization.

### BRIEF DESCRIPTION OF DRAWINGS

The patent application is further detailed hereinafter with reference to the drawings and embodiments.

FIG. 1 is a structural schematic view of a wave potential energy collector in an energy collector according to the patent application;

FIG. 2 is a structural schematic view of a wind energy collector in the energy collector according to the patent application;

FIG. 3 is a structural schematic view of installing a piston of the wind energy collector in FIG. 2;

FIG. 4 is a structural schematic view of a telescoping type sleeve hydraulic cylinder while stretching in the energy collector according to the patent application; and

FIG. 5 is a structural schematic view of the telescoping type sleeve hydraulic cylinder while retracting in the energy collector according to the patent application.

In the FIGs:

1 refers to hydraulic cylinder, 2 refers to hydraulic motor, 3 refers to water carrying wheel, 4 refers to water inlet pipe, 5 refers to water outlet pipe, 6 refers to one-way valve a, 7 refers to one-way valve b, 8 refers to water carrying pipe, 9 refers to metal floating block, 10 refers to wind wheel, 11 refers to turnplate, 12 refers to transmission, 13 refers to a drive rod, 14 refers to a piston, 15 refers to a sleeve piston, 16 refers to a cylinder body, 17 refers to a driving belt, and 18 refers to a linkage

### DETAILED DESCRIPTION

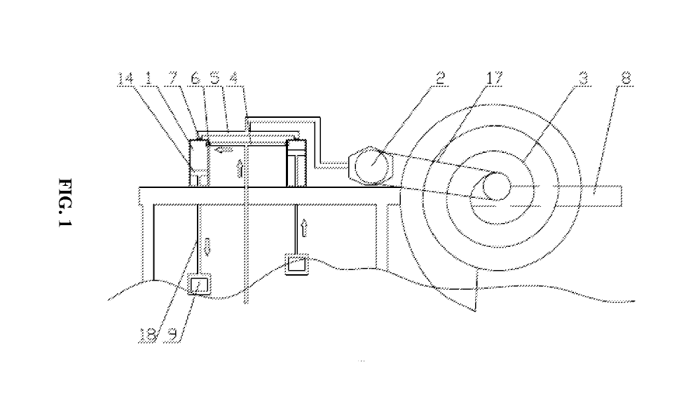

As shown in FIG. 1, the energy collector in the embodiment comprises a hydraulic cylinder 1, a hydraulic motor 2 and a water carrying wheel 3. A piston 14 in the hydraulic cylinder 1 is connected with a reciprocating type running gear. A water inlet pipe 4 and a water outlet pipe 5 are installed on the hydraulic cylinder 1. A one-way valve a6 is arranged in the water inlet pipe 4, and a one-way valve b7 is arranged in the water outlet pipe 5. The water outlet pipe 5 is connected with the hydraulic motor 2. The hydraulic motor 2 is connected with the water carrying wheel 3 through a driving belt 17. A water carrying pipe 8 is installed in the middle of the water carrying wheel 3. The water carrying wheel 3 is provided with a spiral pipeline. One end of the pipeline is connected with the water carrying pipe 8 so that the seawater in the pipeline is poured into the end of the water carrying pipe connected with the water carrying pipe in a spiral manner during a rotating process of the water carrying wheel 3, thus improving a water level. The reciprocating type running gear is a metal floating block 9. The metal floating block 9 is arranged on a sea surface and is connected with the piston 14 through a linkage 18.

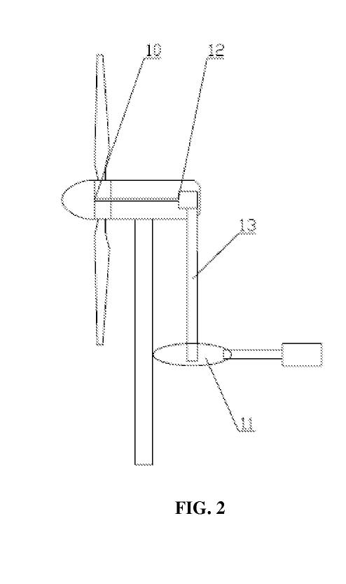

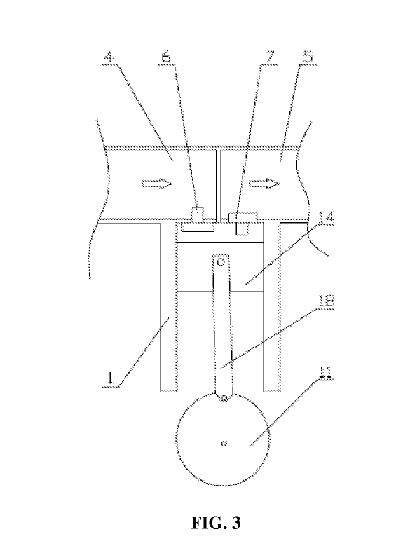

As shown in FIG. 2 and FIG. 3, in the embodiment, the reciprocating type running gear is a wind wheel 10 and a turnplate 11. The wind wheel 10 is connected with a drive rod 13 through a transmission 12. The turnplate 11 is installed on the bottom of the drive rod 13. The piston 14 is hinged with the linkage 18. The linkage 18 is hinged at the edge of the turnplate 11.

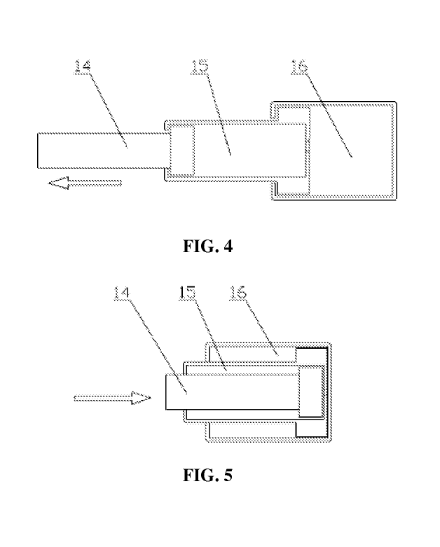

As shown in FIG. 4 and FIG. 5, in the foregoing two embodiments, the hydraulic cylinder 1 is a sleeve type hydraulic cylinder. The piston 14 is sleeved in a sleeve piston 15. The sleeve piston 15 is sleeved in a cylinder body 16.

While working:

As shown in FIG. 1, in the embodiment, sea wave heaves and drives the metal floating block 9 to reciprocate up and down, and enables the piston 14 to reciprocate up and down in the hydraulic cylinder 1 through the linkage 18. When the seawater rises, the piston 14 suffers a buoyancy through the metal floating block 9 and moves upwards. At this time, the one-way valve b7 is turned on; the seawater in the hydraulic cylinder 1 enters the water outlet pipe 5. Meanwhile, the one-way valve a6 is turned off, and the seawater in the hydraulic cylinder 1 flows back to the water inlet pipe 4. When the seawater drops, the piston 14 moves downwards through the gravity of the metal floating block 9. At this time, the one-way valve a6 is turned on, and the seawater enters the hydraulic cylinder 1 through the water inlet pipe 4. Meanwhile, the one-way valve b7 is turned off, so that the seawater in the water outlet pipe 5 will not flow back into the hydraulic cylinder 1. The hydraulic motor 2 operates through the seawater outputted from the inside of the water outlet pipe 5, drives the water carrying wheel 3 to pour in the seawater through the driving belt 17, enables the seawater to flow into the middle of the water carrying wheel 3 through a pipeline inside the water carrying wheel 3 and retracting to the center in a spiral manner, and enables the seawater to finally flow into a water storage device through the water carrying pipe 8.

As shown in FIG. 2, and FIG. 3, in the embodiment, the wind wheel 10 is driven by wind to rotate, and is matched with the drive rod 13 through the transmission 12 to transmit rotation to the turnplate 11. The turnplate 11 rotates and drives the hinged linkage 18 to rotate centrifugally. The linkage 18 drives the piston 14 to reciprocate. When the turnplate 11 rotates and enables the piston 14 to move upwards, the one-way valve b7 is turned on at this time, and the seawater in the hydraulic cylinder 1 enters the water outlet pipe 5. Meanwhile, the one-way valve a6 is turned off to prevent the seawater in the hydraulic cylinder 1 from flowing back into the water inlet pipe 4. When the turnplate 11 rotates and enables the piston 14 to move downwards, the one-way valve a6 is turned on at this time, and the seawater enters the inside of the hydraulic cylinder 1 through the water inlet pipe 4. Meanwhile, the one-way valve b7 is turned off, so that the seawater in the water outlet pipe 5 cannot flow back into the hydraulic cylinder 1. The water outlet pipe 5 is connected with the hydraulic motor 2 in FIG. 1. The hydraulic motor 2 operates through the seawater outputted from the water outlet pipe 5, drives the water carrying wheel 3 to pure in the seawater through the driving belt 17, enables the seawater to flow into the middle of the water carrying wheel 3 through a pipeline inside the water carrying wheel 3 and retracting to the center in a spiral manner, and enables the seawater to finally flow into a water storage device through the water carrying pipe 8.

As shown in FIG. 4 and FIG. 5, in the foregoing two embodiments, when the piston 14 moves upwards, the piston firstly extrudes the sleeve piston 15 to the inside and then continuously extrudes the cylinder body 16 to the inside.

The energy collector adopts maximum efficiency and smaller cost to convert natural energy into mechanical energy, pneumatic energy or electric energy under the premise of not emitting any greenhouse gas and not changing the ecological environment.

What is claimed is:

1. An energy collector, comprising a hydraulic cylinder (1), a hydraulic motor (2) and a water carrying wheel (3), wherein a piston (14) in the hydraulic cylinder (1) is connected with a reciprocating type running gear; a water inlet pipe (4) and a water outlet pipe (5) are installed on the hydraulic cylinder (1); a one-way valve a(6) is arranged in the water inlet pipe (4); a one-way valve b(7) is arranged in the water outlet pipe (5); the water outlet pipe (5) is connected with the hydraulic motor (2); the hydraulic motor (2) is connected with the water carrying wheel (3) in a transmission manner; and a water carrying pipe (8) is installed in the middle of the water carrying wheel (3).

2. The energy collector according to claim 1, wherein the water carrying wheel (3) is provided with a spiral pipeline; one end of the pipeline is connected with the water carrying pipe (8), so that the seawater in the pipeline is poured into the end of the water carrying pipe (8) connected with the water carrying pipe in a spiral manner during a rotating process of the water carrying wheel (3), thus improving a water level.

3. The energy collector according to claim 1, wherein the reciprocating type running gear is a metal floating block (9); the metal floating block (9) is arranged on a sea surface and is connected with the piston (14) through a linkage (18).

4. The energy collector according to claim 1, wherein the reciprocating type running gear is a wind wheel (10) and a turnplate (11); the wind wheel (10) is connected with a drive rod (13) through a transmission (12); the turnplate (11) is installed on the bottom of the drive rod (13); the piston (14) is hinged with the linkage (18); and the linkage (18) is hinged at the edge of the turnplate (11).

5. The energy collector according to claim 1, wherein the hydraulic cylinder (1) is a sleeve type hydraulic cylinder; the piston (14) is sleeved in a sleeve piston (15); and the sleeve piston (15) is sleeved in a cylinder body (16).

6. The energy collector according to claim 1, wherein the hydraulic motor (2) is connected with the water carrying wheel (3) through a driving belt (17).
